(19) United States
(12) Patent Application Publication
(10) Pub. No.: US 2024/0078851 A1
(43) Pub. Date: Mar. 7, 2024

(54) SYSTEMS AND METHODS FOR PREDICTING ENERGY CONSUMPTION IN VEHICLES

(71) Applicant: Ford Global Technologies, LLC, Dearborn, MI (US)

(72) Inventors: Kai Wu, PITTSBURGH, PA (US); Chen Zhang, Dearborn, MI (US); Zhen Hu, Dearborn, MI (US); Yan Fu, Bloomfield Hills, MI (US); David McCreadie, Ann Arbor, MI (US); Sunil Goyal, Canton, MI (US)

(73) Assignee: Ford Global Technologies, LLC, Dearborn, MI (US)

(21) Appl. No.: 17/929,238

(22) Filed: Sep. 1, 2022

(51) Int. Cl. G07C 5/08; B60L 58/12; G07C 5/00

(52) U.S. Cl. CPC G07C 5/0808; B60L 58/12; G07C 5/008; G08G 1/0104

(57) ABSTRACT

The disclosure generally pertains to systems and methods for predicting energy consumption in vehicles. In an example method, a predicted energy consumption model associated with a vehicle may be determined. Sensor data associated with the vehicle may be received via a plurality of sensors associated with the vehicle. A driver-based energy consumption model associated with the vehicle may then be determined based at least in part on the sensor data. An estimated energy consumption model associated with the vehicle may then be determined based at least in part on the predicted energy consumption model and the driver-based energy consumption model. A vehicle charging prediction model may then be determined based at least in part on the estimated energy consumption model.

### BACKGROUND

As electric vehicles grow in popularity, it may be desirable to increase the availability and efficiency of electricity infrastructure and/or local utilities that may support the use of electric vehicles. In order to do so, it may be desirable to forecast charging patterns and/or energy consumption associated with electric vehicles and/or their drivers. However, the predictability of charging patterns and/or energy consumption associated with electric vehicles and their drivers may be constrained by a limited amount of presently available data associated with electric vehicles. It may thus be preferable to incorporate energy consumption models associated with gasoline-powered vehicles and/or hybrid vehicles to predict charging patterns and/or energy consumption associated with electric vehicles.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system for predicting energy consumption in vehicles in accordance with an embodiment of the disclosure.

FIG. 2 illustrates an example implementation of a system for predicting energy consumption in vehicles in accordance with an embodiment of the disclosure.

FIG. 3 illustrates an example implementation of a system for predicting energy consumption in vehicles in accordance with an embodiment of the disclosure.

FIG. 4 depicts a flow chart of an example method for predicting energy consumption in vehicles in accordance with the disclosure.

FIG. 5 depicts a block diagram of an example machine upon which any of one or more techniques (e.g., methods) may be performed, in accordance with an embodiment of the disclosure.

### DETAILED DESCRIPTION

### Overview

In terms of a general overview, certain embodiments described in this disclosure are directed to systems and methods for predicting energy consumption in vehicles. In an example method, a predicted energy consumption model associated with a vehicle may be determined. Sensor data associated with the vehicle may be received via a plurality of sensors associated with the vehicle. A driver-based energy consumption model associated with the vehicle may then be determined based at least in part on the sensor data. An estimated energy consumption model associated with the vehicle may then be determined based at least in part on the predicted energy consumption model and the driver-based energy consumption model. A vehicle charging prediction model may then be determined based at least in part on the estimated energy consumption model.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “vehicle driver” may be used interchangeably with the phrase “vehicle owner,” the word “user,” and the word “driver.” Either word as used herein refers to any individual that is utilizing the vehicle for which an energy consumption is being predicted. The word “sensor” may be any of various sensors that can be found in a vehicle, such as cameras, radar sensors, Lidar sensors, sound sensors, accelerometers, location sensors, and any other sensors.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

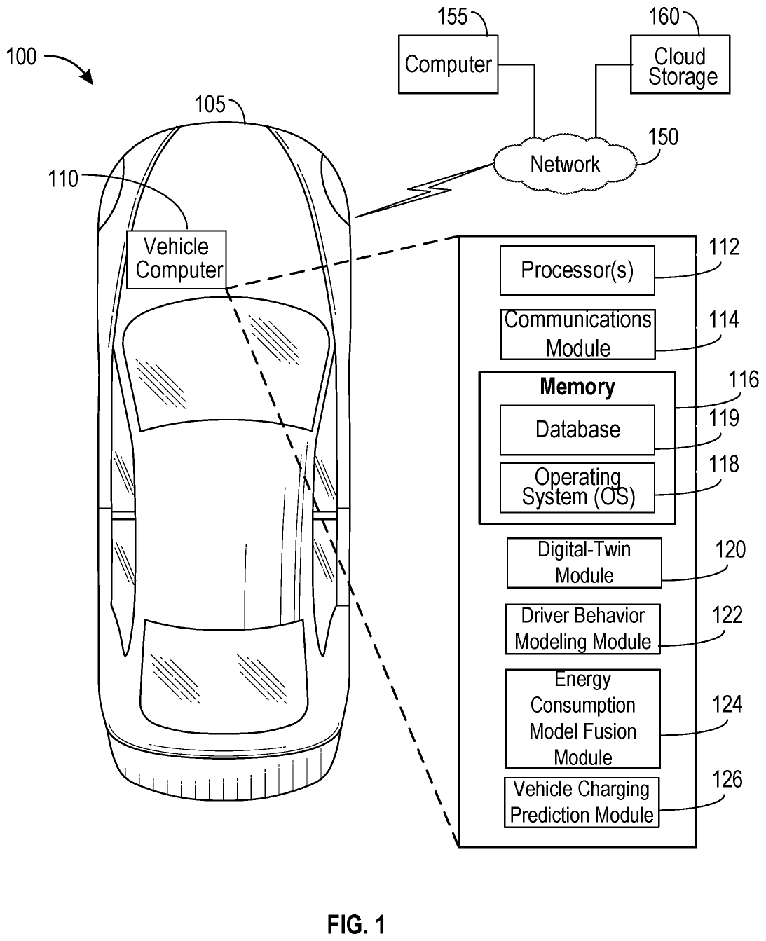

FIG. 1 illustrates an example system 100 for predicting energy consumption in vehicles in accordance with an embodiment of the disclosure. The system 100 may be carried out by a vehicle 105, which may be any of various types of vehicles such as, for example, an electric vehicle, a hybrid electric vehicle, an autonomous vehicle, a sedan, a van, a minivan, a sports utility vehicle, a truck, a station wagon, or a bus. The system 100 may be used to predict the energy consumption of the vehicle 105.

The vehicle 105 may further include components such as, for example, a vehicle computer 110. The vehicle 105 may further include various types of sensors and detectors configured to provide various functionalities. For example, the vehicle 105 may include cameras, radar sensors, Lidar sensors, sound sensors, accelerometers, location sensors, and any other sensors. The vehicle computer 110 may perform various operations associated with the vehicle 105, such as controlling engine operations like turning the vehicle 105 on and off, fuel injection, speed control, emissions control, braking, and other engine operations.

In some embodiments, the vehicle computer 110 may include a processor 112, a communications module 114, and a memory 116. It must be understood that the communications module 114 is a functional block that can be implemented in hardware, software, or a combination thereof. An example hardware component may include a signal processor. An example software component may include a signal processing module. The processor 112 may carry out various operations by executing computer-readable instructions stored in the memory 116. The memory 116, which is one example of a non-transitory computer-readable medium, may be used to store a database 119 for storing data and an operating system (OS) 118.

In some embodiments, the vehicle computer 110 may be configured to include various components having functions associated with providing the system 100. For example, the vehicle computer 110 may assist in predicting an energy consumption of the vehicle 105. In some embodiments, the vehicle computer 110 may further include a digital-twin module 120, a driving behavior modeling module 122, an energy consumption model fusion module 124, and a vehicle charging prediction module 126. The digital-twin module 120, the driving behavior modeling module 122, the energy consumption model fusion module 124, and the vehicle charging prediction module 126 may work in conjunction to assist in predicting the energy consumption of the vehicle 105. In an example embodiment, the vehicle computer 110 may be communicatively coupled to other components of the vehicle 105 via wired and/or wireless connections. More particularly, the vehicle computer 110 may be communicatively coupled to the vehicle 105 via a vehicle bus that uses a controller area network (CAN) bus protocol, a Media Oriented Systems Transport (MOST) bus protocol, and/or a CAN flexible data (CAN-FD) bus protocol. In another embodiment, the communications may be provided via wireless technologies such as Bluetooth®, Ultra-Wideband (UWB), cellular, Wi-Fi, ZigBee®, or near-field communications (NFC).

In some embodiments, the vehicle computer 110 is configured to communicate via a network 150 with devices located outside the vehicle 105, such as, for example, a computer 155 (a server computer, a cloud computer, etc.) and/or a cloud storage device 160. In some embodiments, instead of predicting the energy consumption of the vehicle 105 at the vehicle computer 110, the energy consumption of the vehicle 105 may be determined at the computer 155 and/or the cloud storage device 160. In some embodiments, each of the computer 155 and/or the cloud storage device 160 may further include a digital twin module, a driver behavior modeling module, an energy consumption model fusion module, and/or a vehicle charging prediction module in order to assist in predicting the energy consumption of the vehicle 105.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communications technologies, such as, for example, TCP/IP, Bluetooth®, near-field communication (NFC), Wi-Fi, Wi-Fi Direct, Ultra-Wideband (UWB), cellular, machine-to-machine communication, and/or man-to-machine communication.

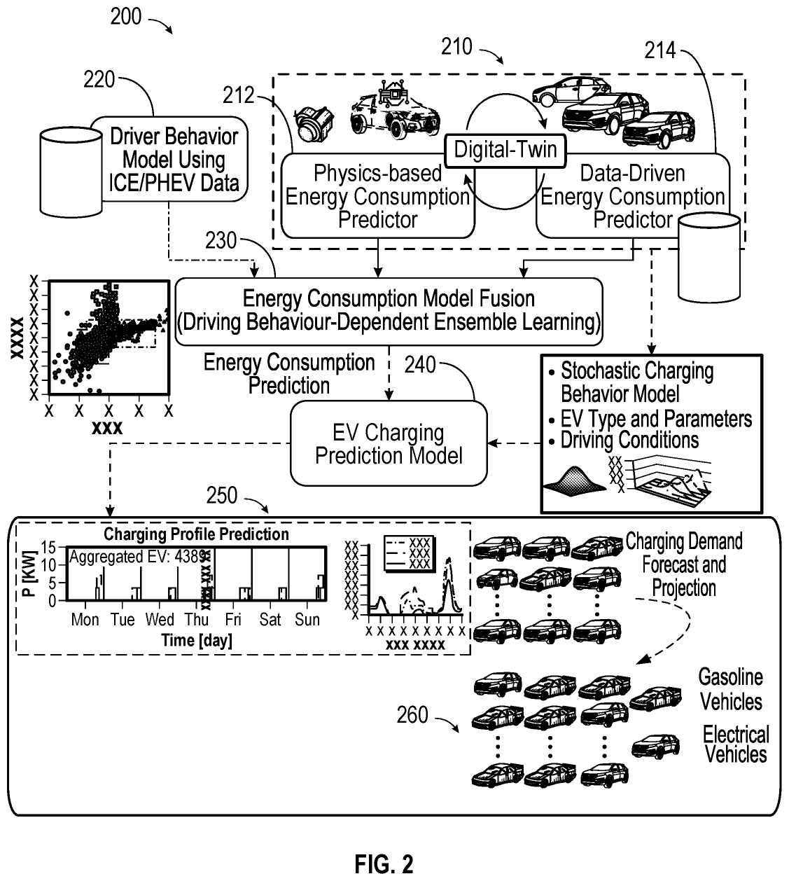

FIG. 2 illustrates an example implementation of a system 200 for predicting energy consumption in vehicles in accordance with an embodiment of the disclosure. The system 200 may be configured to predict an energy consumption of a vehicle, for example, the vehicle 105 depicted in FIG. 1. The vehicle may be an electric vehicle. In some embodiments, as depicted in FIG. 2, the system 200 may include a digital twin module 210. In some embodiments, the digital twin module 210 may include a physics-based energy consumption predictor 212 and a data-driven energy consumption predictor 214. In some embodiments, the integration of both the physics-based energy consumption predictor 212 and the data-driven energy consumption predictor 214 may be preferred due to each predictor having its own benefits. For example, the physics-based energy consumption predictor 212 may provide a more robust simulation, and the data-driven energy consumption predictor 214 may provide the additional benefit of providing sensor data associated with a vehicle so as to account for driver-specific behaviors when predicting the energy consumption of the vehicle. Further, the application of only the physics-based energy consumption predictor 212 may result in prediction errors if training data for the physics-based energy consumption predictor 212 is limited. Such instances may arise, for example, in the case of a new electric vehicle under certain driving conditions.

The digital twin module 210 thus assists in predicting the energy consumption of a vehicle by utilizing the data-driven energy consumption predictor 214, which is then refined by features derived through a transferred learning process from the physics-based energy consumption predictor 212. As such, the digital twin module 210 may be configured to determine a predicted energy consumption model associated with the vehicle based on the physics-based energy consumption predictor 212 and the data-driven energy consumption predictor 214, both of which are associated with the vehicle. The digital twin module 210 may further train the predicted energy consumption model associated with the vehicle for various driving scenarios, including various weather conditions, various traffic densities, and/or various vehicle locations.

In some embodiments, as depicted in FIG. 2, the system 200 may include a driver behavior modeling module 220. In some embodiments, the driver behavior modeling module 220 may engage in analysis of a vehicle driver's behavior and modeling of predictive energy consumption associated with the vehicle based on on-road big data and/or sensor data associated with the vehicle. The driver behavior modeling module 220 may involve techniques associated with big data analytics and artificial intelligence and machine learning algorithms. For example, big data analytics may be utilized to process on-road data and/or sensor data. On-road data and/or sensor data may be obtained from sensors at a vehicle and/or from sensors located at infrastructure proximate to the vehicle. On-road data and/or sensor data may also be obtained from a transportation mobility cloud server and/or databases that store such data. In some instances, the on-road data and/or sensor data may be decoded, cleaned, and analyzed in order to predict an energy consumption associated with the vehicle at the driver behavior modeling module 220. Further, the driver behavior modeling module 220 may be configured to develop statistical models to model the relationship between a charging time associated with the vehicle, a state of charge associated with the vehicle, a probability of the vehicle being plugged into a charging outlet, a type of the vehicle, and/or variables related to the vehicle driver's behavior. The driver behavior modeling module 220 may then develop a driver-based energy consumption model using the on-road data and/or the sensor data.

In some instances, deep learning techniques may be used to predict the energy consumption associated with the vehicle for various driving behaviors and/or conditions. For example, on-road data and/or sensor data may be converted into an input to a deep learning model, and the deep learning model may then be trained using the on-road data and/or sensor data. In some instances, if an accuracy of the deep learning model meets an accuracy threshold value, the driver-based energy consumption model may then be determined based on the deep learning model and the on-road data and/or the sensor data.

In some embodiments, global sensitivity analysis may be utilized at the driver behavior modeling module 220 to more accurately quantify the impact of various input variables, for example, on-road data, on various output variables. Global sensitivity methods may include Fourier Amplitude Sensitivity Tests, Kullback-Leibler divergence scores, Sobol indices (also known as variance-based sensitivity analysis), and/or other applicable methods in order to develop the driver-based energy consumption model.

In some embodiments, the driver behavior modeling module 220 may utilize on-road data and/or sensor data associated with hybrid vehicles and/or gasoline-powered vehicles. In some instances, the hybrid vehicles and/or gasoline-powered vehicles may be convertible into an electric vehicle. As such, the driver behavior modeling module 220 may develop the driver-based energy consumption model based on a driver's behavior while driving a hybrid vehicle and/or gasoline-powered vehicle. The driver-based energy consumption model may then be applied to model energy consumption associated with the same driver when the driver is driving an electric vehicle.

In some embodiments, as depicted in FIG. 2, the system 200 may additionally include an energy consumption model fusion module 230. The energy consumption model fusion module 230 may determine an estimated energy consumption model associated with a vehicle based on both the predicted energy consumption model and the driver-based energy consumption model. The energy consumption model fusion module 230 thus utilizes both physics-based models (for example, the physics-based energy consumption predictor 212) and data-driven models (for example, the data-driven energy consumption predictor 214 and the driver-based energy consumption model) in order to develop the estimated energy consumption model using a transfer learning approach.

The energy consumption model fusion module 230 may further utilize a library of available data-driven and/or physics-based energy consumption prediction models to train the estimated energy consumption model for a variety of driving scenarios and driving conditions. For example, the estimated energy consumption model may be trained for various weather conditions, traffic density, and/or vehicle locations (for example, whether the vehicle is located on a freeway, an arterial road, an urban street, or another location). The energy consumption model fusion module 230 may thus develop at least one energy consumption algorithm to ensure high accuracy prediction of energy consumption at the vehicle given a particular driver in various driving scenarios and/or driving conditions. In some instances, the energy consumption model fusion module 230 may select between competitive-ensemble and cooperative-ensemble forecasting methods in order to determine the preferred forecasting method for each of a particular driver, a particular vehicle type, and a particular driving scenario or driving condition. In some instances, the estimated energy consumption model associated with an electric vehicle may be based at least in part on operation data associated with a plurality of non-electric vehicles.

In some embodiments, as depicted in FIG. 2, the system 200 may further include a vehicle charging prediction module 240. The vehicle charging prediction module 240 may determine a vehicle charging prediction model based on the estimated energy consumption model. In some embodiments, the vehicle charging prediction model may be further based on a stochastic charging behavior model that is generated by the data-driven energy consumption predictor 214. In some embodiments, the vehicle charging prediction model may be further configured to depend on a vehicle type, parameters associated with the vehicle, and/or driving conditions at a location of the vehicle. In some embodiments, the vehicle charging prediction model may be further used to predict a charging pattern 250 associated with the vehicle. The charging pattern 250 associated with the vehicle may be further based on the statistical models generated by the driver behavior modeling module 220. After the charging pattern 250 associated with the vehicle is determined, at least one electricity infrastructure may be implemented at a geographic area associated with the vehicle based at least in part on the charging pattern 250, which may predict future charging demand 260 associated with the vehicle. The electricity infrastructure may include a charging station, a power supply, and/or other infrastructure used to support charging of electric vehicles. The charging pattern 250 associated with the vehicle may be further used in making fleet purchase and/or management decisions and eco-routing determinations.

In some embodiments, as depicted in FIG. 2, the system 200 may additionally aggregate charging patterns 250 across various vehicles in order to forecast a total estimated amount of charging demand 260 at a particular location at any given point in time. The system 200 may thus be able to implement electricity infrastructure based on the total estimated amount of charging demand 260 at each particular location at each given point in time.

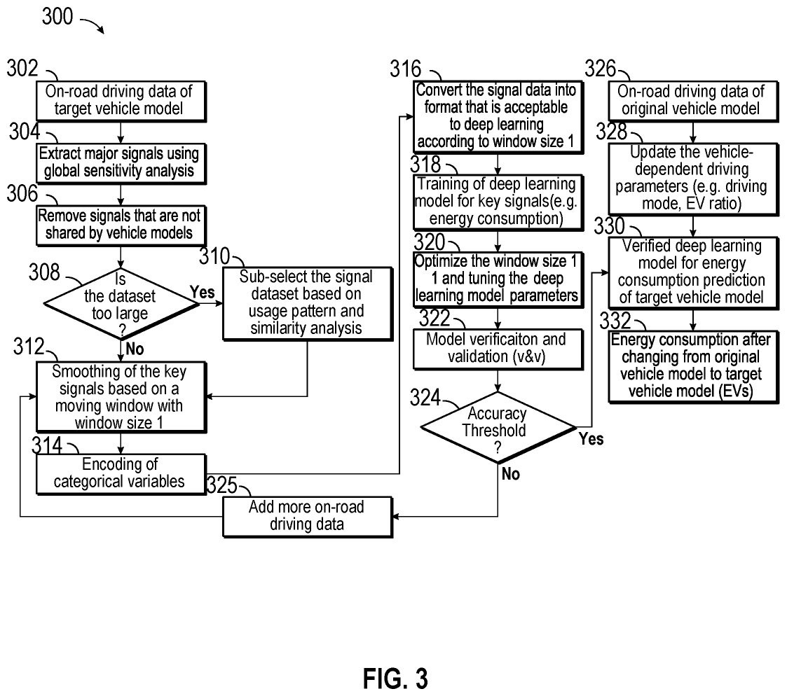

FIG. 3 illustrates an example implementation of system 300 for predicting energy consumption in vehicles in accordance with an embodiment of the disclosure. More specifically, the system 300 may utilize a driver-based energy consumption model in order to determine an estimated energy consumption model associated with a vehicle. The driver-based energy consumption model may be determined at a driver behavior modeling module, for example, the driver behavior modeling module depicted in FIG. 2. In one example, as depicted in FIG. 3, at step 302, on-road data and/or sensor data associated with a target vehicle may be received. The target vehicle may be an electric vehicle associated with a driver. At step 304, major signals may be extracted from the on-road data and/or sensor data using global sensitivity analysis. At step 306, signals that are not shared by similar vehicles may be removed. At step 308, it may be determined if the remaining dataset is too large. If the remaining dataset is too large, at step 310, a subset of the signals may be further selected based on usage patterns associated with the vehicle and similarity analysis before proceeding to step 312. If the remaining dataset is not too large, at step 312, key signals may be smoothed based on a moving window having window size one. Subsequently, at step 314, categorical variables are encoded.

In some embodiments, at step 316, the remaining signal data may be converted into a format that is acceptable for input into a deep learning model according to window size one. At step 318, the deep learning model may be trained for key signals. For example, energy consumption may be one of the key signals. At step 320, the window size one may be optimized, and the parameters associated with the deep learning model may be tuned. At step 322, the deep learning model may be verified and validated. At step 324, it may be determined if the accuracy of the deep learning model meets an accuracy threshold. If the accuracy of the deep learning model fails to meet an accuracy threshold, at step 325, additional on-road data and/or sensor data may be added, and steps 312, 314, 316, 318, 320, 322, and 324 may be repeated.

In some embodiments, at step 326, on-road data and/or sensor data associated with an original vehicle may be received. The original vehicle may be a gasoline-powered vehicle or a hybrid vehicle associated with the same driver. At step 328, vehicle-dependent driving parameters may be updated. For example, a driving mode associated with the target vehicle, a ratio associated with a number of electric vehicles in the geographic area, and other relevant vehicle-dependent driving parameters may be updated. At step 330, if the accuracy of the deep learning model meets the accuracy threshold, the deep learning model may be applied in conjunction with the on-road data and/or the sensor data of the original vehicle and the updated vehicle-dependent driving parameters in order to predict an energy consumption associated with the target vehicle. At step 332, an energy consumption associated with the target vehicle may be predicted.

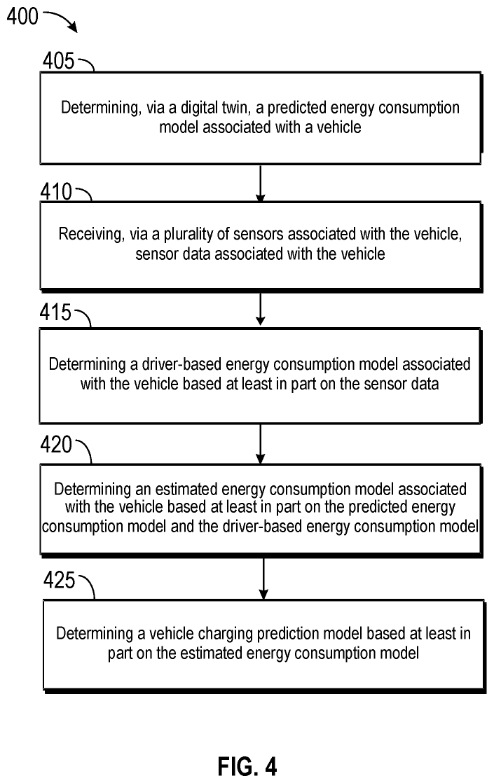

FIG. 4 shows a flow chart 400 of an example method for predicting energy consumption in vehicles in accordance with the disclosure. The flow chart 400 illustrates a sequence of operations that can be implemented in hardware, software, or a combination thereof. In the context of software, the operations represent computer-executable instructions stored on one or more non-transitory computer-readable media such as a memory 116 provided in the vehicle computer 110, that, when executed by one or more processors such as the processor 112 provided in the vehicle computer 110, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 400 may be carried out by the vehicle computer 110 either independently or in cooperation with other devices such as, for example, other components of the vehicle 105 and cloud elements (such as, for example, the computer 155 and cloud storage 160.

At block 405, a predicted energy consumption model associated with a vehicle may be determined via a digital twin. In some embodiments, the determination of the predicted energy consumption model associated with the vehicle may further include the determination of a physics-based energy consumption predictor associated with the vehicle, the determination of a data-driven energy consumption predictor associated with the vehicle, and the subsequent determination of the predicted energy consumption model associated with the vehicle based on the physics-based energy consumption predictor and the data-driven energy consumption predictor. In some embodiments, the predicted energy consumption model may be trained for a plurality of driving scenarios, where the plurality of driving scenarios includes at least one of a weather condition, a traffic density, and a vehicle location.

At block 410, sensor data associated with the vehicle may be received via a plurality of sensors associated with the vehicle.

At block 415, a driver-based energy consumption model associated with the vehicle may be determined based at least in part on the sensor data. In some embodiments, the determination of the driver-based energy consumption model associated with the vehicle based at least in part on the sensor data may further include the conversion of the sensor data into an input to a deep learning model, the training of the deep learning model using the sensor data, the determination of whether an accuracy of the deep learning model meets an accuracy threshold value, and, responsive to the determination that the accuracy of the deep learning model meets the accuracy threshold value, the determination of the driver-based energy consumption model associated with the vehicle based at least in part on the sensor data and the deep learning model.

At block 420, an estimated energy consumption model associated with the vehicle may be determined based at least in part on the predicted energy consumption model and the driver-based energy consumption model.

At block 425, a vehicle charging prediction model may be determined based at least in part on the estimated energy consumption model.

In some embodiments, a charging pattern associated with the vehicle may be predicted based at least in part on the vehicle charging prediction model. In some embodiments, at least one electricity infrastructure may be implemented at a geographic area associated with the vehicle based at least in part on the charging pattern associated with the vehicle.

In some embodiments, the vehicle may be an electric vehicle. Operation data associated with a plurality of vehicles may be received, wherein the plurality of vehicles comprises non-electric vehicles, and the estimated energy consumption model associated with the vehicle may be determined based at least in part on the operation data.

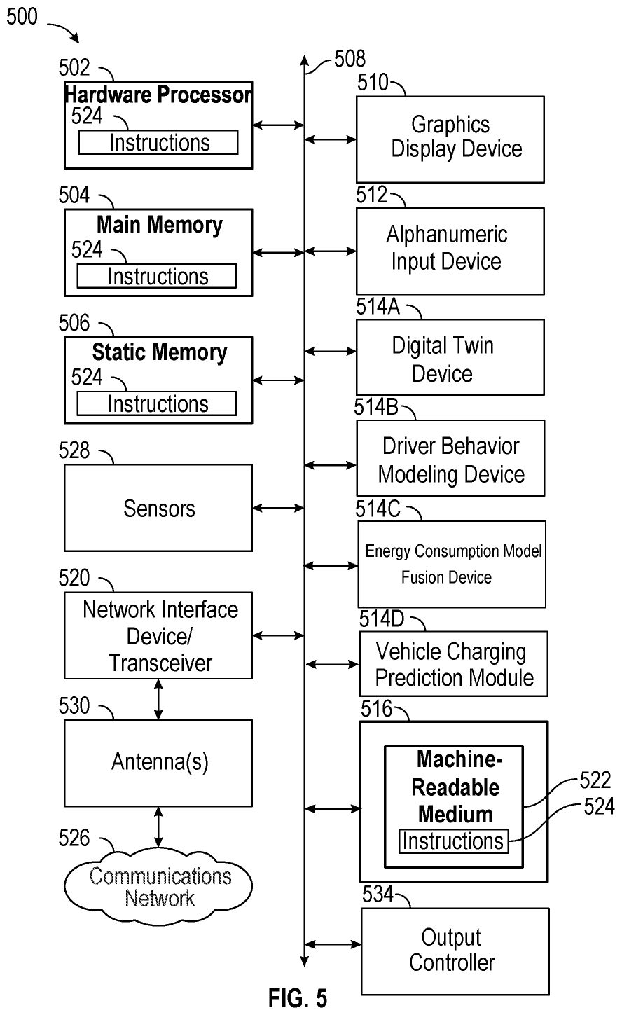

FIG. 5 depicts a block diagram of an example machine 500 upon which any of one or more techniques (e.g., methods) may be performed, in accordance with one or more example embodiments of the present disclosure. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. In some embodiments, the machine 500 may be the vehicle 105, as depicted in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a graphics display device 510, an alphanumeric input device 512 (e.g., a keyboard), a digital twin device 514A, a driver behavior modeling device 514B, an energy consumption model fusion device 514C, and a vehicle charging prediction module 514D. In an example, the graphics display device 510, the alphanumeric input device 512, the digital twin device 514A, the driver behavior modeling device 514B, the energy consumption model fusion device 514C, and the vehicle charging prediction module 514D may be a touch screen display. The machine 500 may additionally include a storage device (i.e., drive unit) 516, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee®, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 112, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 116, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, via a digital twin, a predicted energy consumption model associated with a vehicle;
receiving, via a plurality of sensors associated with the vehicle, sensor data associated with the vehicle;
determining a driver-based energy consumption model associated with the vehicle based at least in part on the sensor data;
determining an estimated energy consumption model associated with the vehicle based at least in part on the predicted energy consumption model and the driver-based energy consumption model; and
determining a vehicle charging prediction model based at least in part on the estimated energy consumption model.

2. The method of claim 1, wherein determining the predicted energy consumption model associated with the vehicle further comprises:
determining a physics-based energy consumption predictor associated with the vehicle;
determining a data-driven energy consumption predictor associated with the vehicle; and
determining the predicted energy consumption model associated with the vehicle based on the physics-based energy consumption predictor and the data-driven energy consumption predictor.

3. The method of claim 1, wherein determining the driver-based energy consumption model associated with the vehicle based at least in part on the sensor data further comprises:
converting the sensor data into an input to a deep learning model;
training the deep learning model using the sensor data;
determining whether an accuracy of the deep learning model meets an accuracy threshold value; and
responsive to the determination that the accuracy of the deep learning model meets the accuracy threshold value, determining the driver-based energy consumption model associated with the vehicle based at least in part on the sensor data and the deep learning model.

4. The method of claim 1, wherein the predicted energy consumption model is trained for a plurality of driving scenarios, and wherein the plurality of driving scenarios comprises at least one of: a weather condition, a traffic density, and a vehicle location.

5. The method of claim 1, further comprising:
predicting a charging pattern associated with the vehicle based at least in part on the vehicle charging prediction model.

6. The method of claim 5, further comprising:
implementing at least one electricity infrastructure at a geographic area associated with the vehicle based at least in part on the charging pattern associated with the vehicle.

7. The method of claim 1, wherein the vehicle comprises an electric vehicle, further comprising:
receiving operation data associated with a plurality of vehicles, wherein the plurality of vehicles comprises non-electric vehicles; and
determining the estimated energy consumption model associated with the vehicle based at least in part on the operation data.

8. A device, comprising:
at least one memory device that stores computer-executable instructions; and
at least one processor configured to access the at least one memory device, wherein the at least one processor is configured to execute the computer-executable instructions to:
determine, via a digital twin, a predicted energy consumption model associated with a vehicle;
receive, via a plurality of sensors associated with the vehicle, sensor data associated with the vehicle;
determine a driver-based energy consumption model associated with the vehicle based at least in part on the sensor data;
determine an estimated energy consumption model associated with the vehicle based at least in part on the predicted energy consumption model and the driver-based energy consumption model; and
determine a vehicle charging prediction model based at least in part on the estimated energy consumption model.

9. The device of claim 8, wherein the determination of the predicted energy consumption model associated with the vehicle further comprises:
determining a physics-based energy consumption predictor associated with the vehicle;
determining a data-driven energy consumption predictor associated with the vehicle; and
determining the predicted energy consumption model associated with the vehicle based on the physics-based energy consumption predictor and the data-driven energy consumption predictor.

10. The device of claim 8, wherein the determination of the driver-based energy consumption model associated with the vehicle based at least in part on the sensor data further comprises:
converting the sensor data into an input to a deep learning model;
training the deep learning model using the sensor data;
determining whether an accuracy of the deep learning model meets an accuracy threshold value; and
responsive to the determination that the accuracy of the deep learning model meets the accuracy threshold value, determining the driver-based energy consumption model associated with the vehicle based at least in part on the sensor data and the deep learning model.

11. The device of claim 8, wherein the predicted energy consumption model is trained for a plurality of driving scenarios, and wherein the plurality of driving scenarios comprises at least one of: a weather condition, a traffic density, and a vehicle location.

12. The device of claim 8, wherein the at least one processor is further configured to execute the computer-executable instructions to:
predict a charging pattern associated with the vehicle based at least in part on the vehicle charging prediction model.

13. The device of claim 12, wherein the at least one processor is further configured to execute the computer-executable instructions to:
implement at least one electricity infrastructure at a geographic area associated with the vehicle based at least in part on the charging pattern associated with the vehicle.

14. The device of claim 8, wherein the vehicle comprises an electric vehicle, and wherein the at least one processor is further configured to execute the computer-executable instructions to:
receive operation data associated with a plurality of vehicles, wherein the plurality of vehicles comprises non-electric vehicles; and
determine the estimated energy consumption model associated with the vehicle based at least in part on the operation data.

15. A non-transitory computer-readable medium storing computer-executable instructions which, when executed by a processor, cause the processor to perform operations comprising:
determining, via a digital twin, a predicted energy consumption model associated with a vehicle;
receiving, via a plurality of sensors associated with the vehicle, sensor data associated with the vehicle;
determining a driver-based energy consumption model associated with the vehicle based at least in part on the sensor data;
determining an estimated energy consumption model associated with the vehicle based at least in part on the predicted energy consumption model and the driver-based energy consumption model; and
determining a vehicle charging prediction model based at least in part on the estimated energy consumption model.

16. The non-transitory computer-readable medium of claim 15, wherein determining the predicted energy consumption model associated with the vehicle further comprises:
determining a physics-based energy consumption predictor associated with the vehicle;
determining a data-driven energy consumption predictor associated with the vehicle; and
determining the predicted energy consumption model associated with the vehicle based on the physics-based energy consumption predictor and the data-driven energy consumption predictor.

17. The non-transitory computer-readable medium of claim 15, wherein determining the driver-based energy consumption model associated with the vehicle based at least in part on the sensor data further comprises:
converting the sensor data into an input to a deep learning model;
training the deep learning model using the sensor data;
determining whether an accuracy of the deep learning model meets an accuracy threshold value; and
responsive to the determination that the accuracy of the deep learning model meets the accuracy threshold value, determining the driver-based energy consumption model associated with the vehicle based at least in part on the sensor data and the deep learning model.

18. The non-transitory computer-readable medium of claim 15, wherein the predicted energy consumption model is trained for a plurality of driving scenarios, and wherein the plurality of driving scenarios comprises at least one of: a weather condition, a traffic density, and a vehicle location.

19. The non-transitory computer-readable medium of claim 15, wherein the operations further comprise:
predicting a charging pattern associated with the vehicle based at least in part on the vehicle charging prediction model; and
implementing at least one electricity infrastructure at a geographic area associated with the vehicle based at least in part on the charging pattern associated with the vehicle.

20. The non-transitory computer-readable medium of claim 15, wherein the vehicle comprises an electric vehicle, and wherein the operations further comprise:
receiving operation data associated with a plurality of vehicles, wherein the plurality of vehicles comprises non-electric vehicles; and
determining the estimated energy consumption model associated with the vehicle based at least in part on the operation data.
